(19) United States
(12) Patent Application Publication
(10) Pub. No.: US 2015/0036952 A1
(43) Pub. Date: Feb. 5, 2015

(54) Bulk Materials Bag Having Anti-Skid Treatment and Method of Applying Treatment

(71) Applicant: Standard Multiwall Bag Manufacturing Co.,, Beaverton, OR (US)

(72) Inventor: Yuming Pang, Beaverton, OR (US)

(21) Appl. No.: 13/959,184

(22) Filed: Aug. 5, 2013

(51) Int. Cl. B65D 33/00; B31B 37/00; B65D 21/02

(52) U.S. Cl. CPC B65D 33/005; B65D 21/0201; B31B 37/00
USPC 383/116; 383/37; 493/211; 493/220

(57) ABSTRACT

An anti-skid treatment is applied to one or both major surfaces of bulk materials bags. The treatment may be applied to any bulk material bag, but is detailed in respect of films that tend to be relatively slippery, such as oriented polypropylene (“OPP”) and biaxially oriented polypropylene (“BOPP”). In one preferred embodiment, an elastomeric polymer having a coefficient of friction higher than that of the bag material is applied in strips to one or both surfaces of the bag. A method of manufacturing the bags is also described.

### TECHNICAL FIELD

The present invention relates to bulk bags manufactured from polypropylene, and more particularly to an anti-skid treatment applied to one or more outer surfaces of such bags to prevent relative movement between adjacent bags in a stack.

### BACKGROUND

Bulk materials bags manufactured from polywoven materials are used the world over to package bulk items ranging from pet foods to foods for human consumption, and ingredients for processing in the food industry. There are several types of materials that are used for such polywoven bags; exemplary films include but are not limited to oriented polypropylene (“OPP”) and biaxially oriented polypropylene (“BOPP”). Each of these types of films demonstrates known and advantageous characteristics for use in manufacturing bulk bags. As a result, bags made from such films have found wide acceptance in a variety of industries.

Bags manufactured with OPP and BOPP film are extremely popular and are in widespread use. Generally described, BOPP film is a polypropylene film that has been stretched in both the machine and cross machine directions. It has excellent working properties. For example, it is resistant to oils and greases, defines a good vapor barrier, demonstrates high clarity and performs well in high speed printing operations. BOPP has an attractive high gloss finish, good puncture and crack resistance and is not affected by moisture and does not shrink with changes in the environment. And there are many closure options available for use with BOPP.

Bags made with BOPP film typically are laminates having an inner layer made out of material that has properties designed to be compatible with the bulk material that will be in the bag. For example, if the bag is being designed to accommodate a bulk food item that has high oil content, the material used for the inner layer is chosen to be compatible with the food product and with the oil content. A middle layer is biaxially oriented woven polypropylene and the outer layer is a print and bonding layer.

But both BOPP and OPP bags are notoriously slippery when stacked atop other like bags. That is, the coefficient of friction between two OPP bags is low so that stacked backs tend to slide relative to one another. When a bulk bag made of BOPP is filed with a heavy material and stacked on another BOPP bag, a number of problems arise due to the slippery nature of the material. For example, when multiple bags are stacked onto a pallet the stack is fairly unstable because the bags in the stack are prone to relative movement. Since the coefficient of friction between the adjacent bags is low, when the pallet is moved during transport the stack of bags on the pallet may become unstable and become upset. Shrink wrapping the stack can help alleviate this stability problem, but it does not eliminate it as relative movement between bags may still occur.

One known solution for stabilizing BOPP and similar bags that tend to be “slippery” when stacked on a pallet is to use so-called “palletizing adhesives.” Palletizing adhesives are applied to one or both facing surfaces of adjacent bags in a stack to effectively increase the coefficient of friction between the bags. There are a variety of such products, but generally described these products are an adhesive that is applied to the upper surface of a bulk bag as the bag is stacked onto a pallet. The adhesive on one bag then binds to the facing surface of the next bag stacked on top of the adhesive-coated bag, thereby stabilizing the stack. There are both hot melt and liquid cold palletizing adhesives and these products have found widespread usage. However, there are known limitations with these methods, including adding expense to the process of palletizing bags, undesired “stickiness” due to applied adhesive, gummy residue left on the bags, the danger of burns using hot melt adhesive (typically applied at temperatures over 250 degrees F.), and package tearing upon separation when a stack of bags is de-stacked.

There is a need therefore for an anti-skid solution that addresses these known limitations of applied palletizing adhesives.

The present invention comprises an anti-skid treatment that is applied to bulk materials bags on one or both of the major outer surfaces of the bags. The anti-skid material is deposited onto the bag surface(s) during manufacturing of the bag and when finished, filled bags are stacked atop one another, the anti-skid material on one bag is pressed against a major surface of an adjacent bag in the stack. Because the anti-skid material increases the coefficient of friction between bags in a stack, relative movement between bags is minimized or eliminated.

Since the anti-skid treatment is applied during manufacturing of the bag, the problems inherent with palletizing adhesives are avoided. The material used for the anti-skid treatment is an elastomeric polymer that is applied to the bag during forming with an extruder. The polymer is non-tacky and does not adversely affect handling of the bag either before or after filling and does not result in package tearing when a stack of bags is unstacked.

Other advantages of the invention will become clear from review of the following description and drawings.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a typical bulk bag manufactured from oriented polypropylene or bio-oriented polypropylene and illustrating the anti-skid treatment according to the present invention on one major surface of the bag.

FIG. 2 is cross sectional view through the bag illustrated in FIG. 1, taken along the line 2-2 of FIG. 1.

FIG. 3 is a schematic side view of three oriented polypropylene or bio-oriented polypropylene bulk bags, each of the bags being filled with bulk materials and each of the bags incorporating the anti-skid treatment according to the invention. In FIG. 3, the three bags are illustrated in a stack atop one another.

FIG. 4 is a side elevation view illustrating a first embodiment of a processing line for manufacturing oriented polypropylene or bio-oriented polypropylene bags having the anti-skid treatment of the invention.

FIG. 5 is side elevation view of a second processing line for manufacturing oriented polypropylene or bio-oriented polypropylene bags according to the present invention.

### DETAILED DESCRIPTION OF ILLUSTRATED EMBODIMENTS

The invention described herein relates to an anti-skid treatment that is applied to film that is commonly used to manufacture bulk material bags. As noted above, exemplary films with which the anti-skid treatment described herein are used include but are not limited to oriented polypropylene (“OPP”), polyolefin (“PO”), and biaxially oriented polypropylene (“BOPP”). The invention is described herein with reference to a typical bulk bag manufactured from BOPP.

The invention will now be described in detail with reference to the drawings. Relative directional terms are used at times to describe components of the invention and relative positions of parts of the invention and equipment for manufacturing bags incorporating the invention. As a naming convention, the plane of the floor in a manufacturing or work space is considered to be a generally horizontal surface. Other relative directional terms correspond to this convention: “upper” refers to the direction above and away from the ground plane; “lower” is generally in the opposite direction, “inward” is the direction from the exterior toward the interior of a bulk bag and “outward” is the opposite direction. “Vertical” is the direction normal to the horizontal ground plane, and so on.

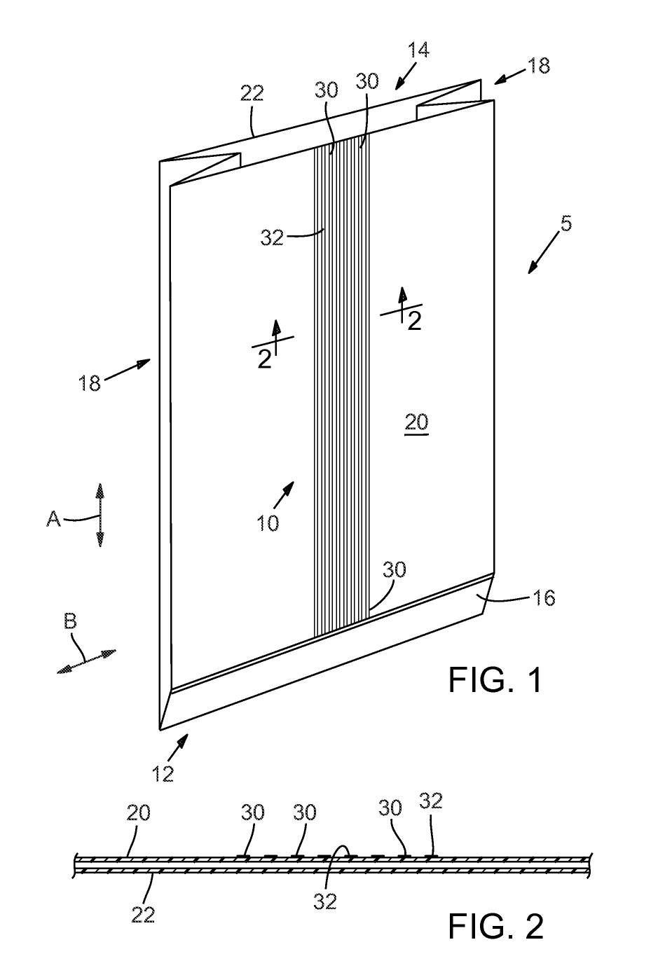

Turning now to the drawings, a first embodiment of a bag 5 incorporating the anti-skid treatment 10 according to the present invention is shown. It will be understood that bag 5 may be any type of bulk bag and is described herein as a typically bulk bag manufactured from BOPP. The bag 5 shown in the drawings is typical of the type of bulk bags that are shipped from the bag manufacturer to the users in a flattened condition with one end of the bag closed and the opposite end open. In the present description, the closed end 12 of bag 10 is sometimes referred to as the “manufactured” end. The open end 14 is sometimes referred to as the “consumer” end because the open end is closed by the consumer after the bag is filled. There are a variety of closure types that may be used to close both the manufactured end 12 and the consumer end 14. In FIG. 1, the manufactured end 12 is closed with a folded-over and glued type of closure 16. The consumer may use the same type of closure to seal the open end 14, or any other standard closure type, including for example sewn closures, which also are typical with bags manufactured from BOPP.

Bags such as bag 5 according to the present invention may be manufactured with gusseted side edges 18 as illustrated herein, or may just as well be made with flat sides. In either case, the bag 5 has a first major surface 20 and an opposite major surface 22. For reference purposes, the bag axis is defined as the axis extending in the direction of arrow A in FIG. 1—that is, the axis that extends along the longitudinal axis of the formed bag. The cross-bag axis is transverse to the bag axis—arrow B in FIG. 1.

Bag 5 includes an anti-skid treatment 10 applied to major surface 20 of the bag and extending along the surface in along the bag axis. Anti-skid treatment 10 is defined by plural strips 30 of an elastomeric polymer material 32 that is applied to the bag according to the process described below. The elastomeric polymer is applied to the bag with a modified extrusion machine during formation of the bag. The material is applied in heated liquid form and dries quickly so that it is not tacky and the strips are bonded onto the major surface 20 and cannot easily be removed therefrom. The anti-skid material when applied to the bag defines an area of the bag that has a higher coefficient of friction (between stacked bags) relative to stacked bags that are untreated. As a result, when plural bags 5 having anti-skid treatment 10 are stacked atop one another, relative movement between the bags is eliminated or minimized so that the stack is stable.

One preferred polymeric material 32 suitable for use with the present invention is a propylene-based, olefinic elastomer that is flexible, elastic and transparent. The polymer must be suitable for thermoplastic application with an extruder and should have excellent adhesion properties for application to BOPP. A propylene-based elastomer meeting these criteria and found to perform well for use with the present invention is currently available from ExxonMobil Chemical and is offered under the brand name VISTAMAXX 6202.

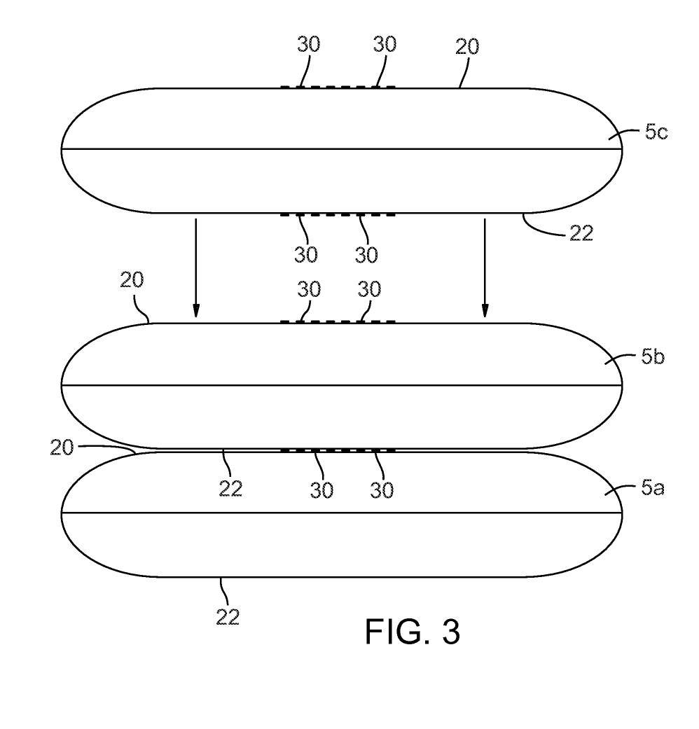

With reference to FIG. 3, a stack of three bags 5a, 5b and 5c is formed with the third bag (5c) shown in the process of being deposited atop bag 5b. Bag 5a is the lowermost bag in the stack. Bags 5a and 5b have anti-skid treatment 10 defined by strips 30 applied to the major surfaces 20 of the bags. When stacked, the “lower” major surface 22 of intermediate bag 5b rests on the “upper” major surface 20 of the lower bag 5a. The area of contact between the bags 5a and 5b where the anti-skid treatment 10, strips 30, are located defines an anti-skid contact area that has a high coefficient of friction.

The polymeric material 32 that is used for the strips 30 causes the coefficient of friction between bags 5a and 5b, and between 5b and 5c to be higher than the coefficient of friction between adjacent bags that do not include strips 30. As such, bags according to the present invention that include the anti-skid treatment 10 define more stable stacks in which the bags are resistant to relative movement to a greater degree. Thus, if we assume that the coefficient of kinetic friction between two BOPP bags that do not include anti-skid treatment 10 is equal to μ_{b}, and that that the coefficient of kinetic friction between two BOPP bags that do incorporate anti-skid treatment 10 described herein is μₐ, then the invention defined herein results in the following: μₐ>μ_{b}.

The strips 30 illustrated in FIGS. 1 and 2 have been applied only to major surface 20 of bags 5. It will be appreciated that the invention contemplates application of strips 30 to both major surface 20 and major surface 22. As an illustration, bag 5c in FIG. 3 has anti-skid treatment 10—strips 30—applied to both major surfaces 20 and 22.

It will be understood that the strips 30 may be relatively wider or narrower than those shown in the drawings and may be greater or fewer in number than shown in the drawings. Finally, those of skill in the art will appreciate that the strips may be arranged and placed differently on the major surface(s) of the bag. Thus, it is possible to have a group of one or more strips 30 near one lateral edge of the bag 5 and a group of one or more strips 30 near the opposite edge of the bag. Similarly, the strips 30 described herein extend along the bag axis. The strips could be applied along the cross bag axis and the strips could be applied in intermittent patches rather than continuous strips.

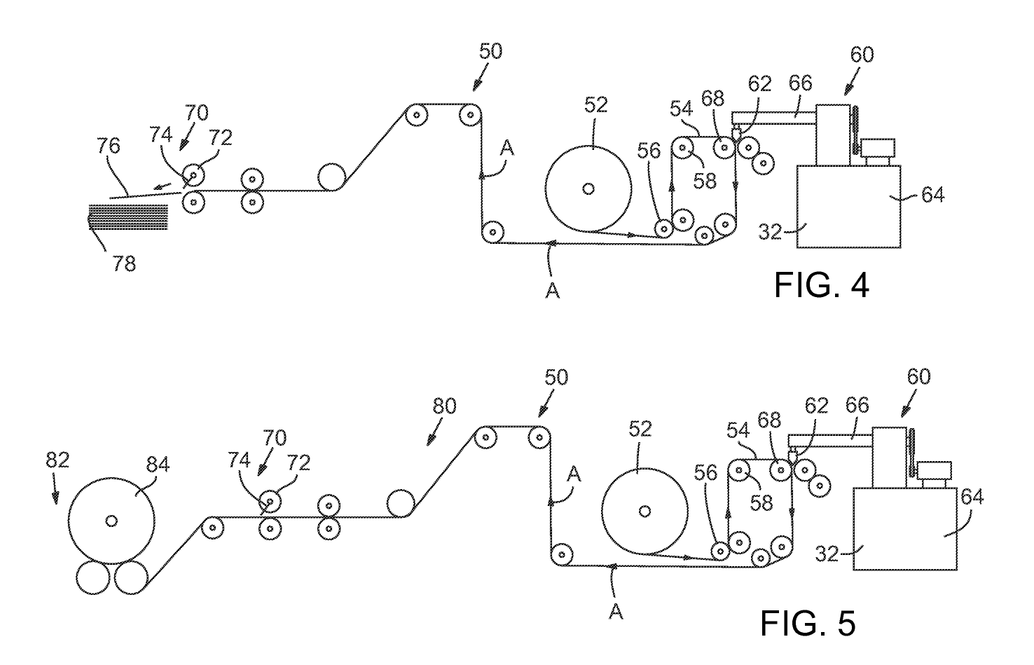

The manufacturing process used to apply anti-skid treatment 10 to bags 5 will now be described with reference to FIGS. 4 and 5. Importantly, the elastomeric polymer 32 that is used to form the strips 30 that define anti-skid treatment 10 is applied after the laminator in a bag forming operation.

A bag making machine 50 is illustrated in FIG. 4. Again, the process described herein beginning with roll 52 occurs after the blank stock BOPP material has been laminated and formed into a tubular condition in a roll. Starting with a roll 52 of BOPP film that has been formed into bag stock 54—that is, the bag stock 54 is a flattened tubular BOPP film that is rolled up in bulk to form the roll 52, the bag stock 54 may be unrolled from roll 52 in a flattened condition as shown in the figures and is routed through a variety of standard rolls such as turn rolls 56, 58 as the stock moves through the bag making machine 50, not all of which are described, and the direction of movement of the stock 54 through machine 50 is shown with arrows A. An extruder 60 is positioned such that an extruder head 62 may deposit strips of elastomeric polymer 32 onto major surface 20 of the bag stock 54 as the stock is moved past the extruder. More specifically, extruder 60 includes a tank 64 that defines a reservoir of the elastomeric polymer 32 in liquid form (typically heated). The extruder includes pumping equipment that delivers polymer 32 from tank 64 through appropriate piping 66 and to extrusion head 62. The extrusion head 62 is positioned adjacent the bag stock 54 so that liquid polymer 32 extruded from extrusion head 62 is deposited onto the stock. In FIG. 4, bag stock 54 is transported over a turn roll 68 such that the stock is between the turn roll and an adjacent roll 70. Extruder head 62 is positioned such that liquid polymer is extruded directly onto the surface 20 of the bag stock as it moves past the extruder head (in along the machine axis). The extruder head is movable and thus may be relocated relative to the bag stock so that strips 30 are deposited in the desired location on surface 20. And as noted, the number and location of strips 30 may be varied and thus the extruder head may take on any number of desired configurations.

Downstream of extruder 60 the bag stock 54 with strips 30 applied thereto continues over various other turn rolls in the downstream direction (arrow A) until the elastomeric polymer 32 is sufficiently dry and the stock 54 passes through a cutter 70. Cutter 70 is largely conventional and includes a cutter roll 72 that has a knife 74 that extends across the cutter roll in the cross bag axis. Individual bags 76 are formed each time the cutter roll 72 makes a complete rotation and the individual bags 76 are formed into a stack 78 for further processing—i.e., closing the manufactured end, shipment to the consumer, etc.

FIG. 5 illustrates a second embodiment of a forming machine 80 that is in all respects relative to the invention described herein identical to the bag making machine 50 described above with reference to FIG. 4. As such, like structures are identified with the same reference numbers. However, in FIG. 5 the forming machine 80 is a roll to roll winding machine with a folder rather than machine that makes individual bags. At the downstream end 82 of forming machine 80, bag stock 54 is rolled into a roll 84 for further processing. Again, it is notable that the polymeric elastomer 32 is applied to bag stock 54 after lamination of the film into the formed stock.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. A bulk materials bag, comprising:
a bag body having first and second opposed major surfaces; and
an anti-skid material applied to at least one of the first or second major surfaces over at least a portion of said first or second surfaces and applied to said surface during formation of said bag.

2. The bulk materials bag according to claim 1 wherein the bulk materials bag comprises oriented polypropylene.

3. The bulk materials bag according to claim 2 wherein the bulk materials bag comprises biaxially oriented polypropylene.

4. The bulk materials bag according to claim 3 wherein the coefficient of kinetic friction between two stacked bags is greater than the coefficient of friction between two stacked bags of the same biaxially oriented polypropylene that do not include said anti-skid material.

5. The bulk materials bag according to claim 4 wherein the anti-skid material comprises an elastomeric polymer.

6. The bulk materials bag according to claim 5 wherein the elastomeric polymer comprises a propylene-based elastomer.

7. The bulk materials bag according to claim 1 wherein the anti-skid material is applied to a major surface of said in plural spaced apart strips.

8. The bulk materials bag according to claim 7 wherein the bag has a bag axis and the strips are applied to said major surface and extend parallel to the bag axis.

9. The bulk materials bag according to claim 8 in which the bag has a length and the plural spaced apart strips cover the entire length of the bag.

10. A first bulk materials bag in combination with a second bulk materials bag in a stack, the combination comprising:
a first bulk materials bag having a bag body with first and second major surfaces and an anti-skid compound applied during formation of said bag to a portion but not all of one of the first or second major surfaces,
a second bulk materials bag having a bag body with first and second major surfaces;
wherein said second bulk materials bag is stacked atop said first bulk materials bag such that one of said major surfaces of said second bulk materials bag is resting on said at least one of said first or second major surfaces of said first materials bag with said anti-skid compound applied thereto such that the portion of the first bulk materials bag having said anti-skid compound applied thereto is in contact with said second bulk materials bag to thereby define an anti-skid contact area, and the portion of the first bulk materials bag that does not have said anti-skid compound applied thereto is in contact with said second bulk bag to thereby a non-anti-skid contact portion, and wherein the coefficient of kinetic friction between the first and second bulk materials bags in the anti-skid contact area is greater than the coefficient of kinetic friction between the first and second bulk materials bags in the non-anti-skid contact area.

11. The combination according to claim 10 wherein the anti-skid compound comprises plural strips of said anti-skid compound applied to said major surface of said first bulk materials bag.

12. The combination according to claim 11 wherein the anti-skid compound is applied to the one of the first or second major surfaces as a liquid during formation of said bulk materials bag.

13. The combination according to claim 12 wherein the anti-skid compound comprises an elastomeric polymer.

14. The combination according to claim 12 wherein the elastomeric polymer further comprises a propylene based elastomer.

15. A method of making a bulk materials bag, comprising the steps of:
a. forming a roll of a tubular bag stock in which said bag stock may be unrolled in a flattened condition;
b. routing the flattened bag stock past an extrusion head;
c. extruding from the extrusion head a liquefied elastomeric polymer onto a surface of the bag stock; and
d. cutting the bag stock into individual bags.
